(19) United States
(12) Patent Application Publication
(10) Pub. No.: US 2003/0084801 A1
(43) Pub. Date: May 8, 2003

(54) Arrangement in doctor blade

(75) Inventor: Ake Boose, Lidingo (SE)

Correspondence Address: MERCHANT & GOULD PC, P.O. BOX 2903, MINNEAPOLIS, MN, 55402-0903, US

(73) Assignee: AKE BOOSE UTVECKLINGS AB, Lidingo (SE)

(21) Appl. No.: 10/264,586

(22) Filed: Oct. 3, 2002

Related U.S. Application Data
(60) Provisional application No. 60/329,276, filed on Oct. 12, 2001.

(30) Foreign Application Priority Data
Oct. 4, 2001 (SE) 0103315-8

(51) Int. Cl. B41F 31/00

(52) U.S. Cl. 101/350.6

(57) ABSTRACT

An arrangement for a chambered doctor blade included in a printing unit having a rotatable cylinder comprises a first force means for applying the doctor blade against the cylinder in an operative position and a second adjustable force means adapted to absorb at least part of a force generated by the first force means. The second force means is automatically adjustable to allow the chambered doctor blade to be moved towards the cylinder in said operative position.

A chambered doctor blade comprises at least one such arrangement for obtaining automatic displacement of the chambered doctor blade relative to the cylinder for the purpose of compensating for any wear on the wiping blades of the chambered doctor blade.

### CROSS-REFERENCE TO RELATED APPLICATIONS

This application claims the benefit of U.S. patent application No. 60/329,276 filed Oct. 12, 2001, and Swedish patent application No. 0103315-8 filed Oct. 4, 2001, all of which are incorporated herein by reference.

### FIELD OF THE INVENTION

The present invention relates to an arrangement for a chambered doctor blade intended for a printing unit. The invention also concerns a chambered doctor blade provided with at least one such arrangement and a printing unit provided with one such chambered doctor blade arrangement.

### BACKGROUND ART

Chambered doctor blades are extensively used in rotary-printing units, especially flexo-printing units, for applying ink, lacquer, adhesive or the like to a rotatable cylinder included in the printing unit. In flexo-printing, a screen roller is used as inking roller. This roller or cylinder has on its circumferential surface recesses/cells that are evenly distributed across generally the whole circumferential surface. By causing the screen roller to run in contact with printing ink that is often of low viscosity, the cells are filled with printing ink, whereupon excess ink is scraped or wiped off by means of a doctor blade which abuts against the roller. A layer of evenly distributed ink is then transferred from the thoroughly wiped screen roller to a soft high-intensity printing form, the flexographic printing plate.

In modern flexo-printing presses, inking and wiping of the screen roller is usually done by means of a chambered doctor blade. Such a chambered doctor blade, which per se functions well, is known, inter alia, from WO 93/24328. A chambered doctor blade of this kind has the form of an elongate inking container or inking chamber which is arranged horizontally and abuts against the screen roller and which has an upper and a lower doctor blade as well as end seals at both ends of the chamber. The doctor blades (lamellae) and the end seals form a close-fitting frame against the circumferential surface of the screen roller. The chambered doctor blade, which during printing is filled with ink, is applied against the rotating screen roller, which causes the cells of the roller to be filled with ink. The function of each doctor blade changes with the direction of rotation of the roller. One of the doctor blades, the wiping doctor blade, wipes off excess ink while the other has only a sealing function.

In order for the screen roller to deliver a predetermined quantity of ink during the entire printing, its circumferential surface has to be wiped in a constant manner. Thus, the doctor blades must abut against the screen roller with a predetermined minimum abutment pressure.

It is also known, inter alia from U.S. Pat. No. 5,735,210, to apply a chambered doctor blade against a screen roller by means of pneumatic/hydraulic cylinders or mechanical springs which press or pull the chambered doctor blade against the roller with a certain force. The application force is determined by the operator and the abutment pressure of the doctor blades is kept at a constant level for the entire service life of the doctor blades.

According to this principle, a very large application force must be used, however, to ensure that the doctor blades wipe off the screen roller in a constant manner. A particularly large force is needed to compensate for the friction inherent in the doctor blade mechanism. In addition, pulsating forces arise between the chambered doctor blade and the screen roller due to thrusts from the printing form and also from the ink feeding pump, in the case where the latter is of membrane type.

The large application force results in increased friction between the doctor blades and the screen roller, which leads to the service life of the doctor blades being shortened. This means that the doctor blades have to be changed more frequently and, thus, that the doctor blade cost will increase. In addition, each change of doctor blade takes time and generates costs in terms of misprints and machine downtime.

Furthermore, more power is required to operate the screen roller in the printing unit, and the wear on the end seals of the chambered doctor blade will be unnecessarily great, which means that the seals also have to be hanged more frequently leading to increased costs.

In the chambered doctor blade according to WO 93/24328 (see FIG. 4, in particular), the main part of the application force is absorbed by adjusting screws (reference numeral 37), and thus only a small part of the total application force is used to apply the doctor blades against the screen roller. The adjusting screws are adjusted manually when positioning new doctor blades with respect to their parallelism with the roller and their abutment pressure against said roller. In order to compensate for the wear of the doctor blades, a manual correction of the position of the chamber in relation to the screen roller is carried out occasionally during printing by regulating the adjusting screws. This allows a lower application pressure to be used.

One disadvantage of the technique disclosed in WO 93/24328, however, is the repeated manual adjustments required to compensate for the wear of the doctor blades and to obtain an optimal abutment of said doctor blades against the screen roller. If the pressure is excessively high, the doctor blades will wear faster than necessary and if the pressure is too low, the screen roller will deliver too much ink. The manual adjustment has to be carried out separately in each printing unit and at both ends of the chambered doctor blade, which is time-consuming and, thus, expensive.

### SUMMARY OF THE INVENTION

In view hereof, the object of the present invention is to provide an improved arrangement for use in connection with a chambered doctor blade in a printing unit, which arrangement completely or partly obviates the above drawbacks associated with prior-art technique.

This object is achieved on the one hand by means of an arrangement having the features recited in independent claim 1 and, on the other hand, by means of a chambered doctor blade having the features as defined in independent claim 9 and a printing unit having the features as defined in independent claim 11.

Additional distinguishing features and advantages of the invention are apparent from the dependent claims and the following description.

By the arrangement of the invention comprising a first force means and a second force means adapted to absorb part of the application force, said second force means being automatically adjustable, the force by which the chambered doctor blade is applied against the roller can be optimized without the need for time-consuming manual adjustments. An optimal application force means that an adequate quantity of ink is delivered from the screen roller and unnecessary misprints are thus avoided. Furthermore, the wear of the doctor blades and end seals is reduced. Fewer doctor blades and end seals are thus required, which implies lower costs. Less wear also implies lower costs since the machine downtime required to change the doctor blades and seals will be reduced.

Preferably, the second force means is adjustably arranged on a rack which is movable relative to the fixed parts of the printing unit and adapted to absorb at least part of the force exerted by the first force means, to allow a first initial positioning of the second force means when the doctor blade is being applied against the roller in an operative position.

Advantageously, the second force means may be a threaded element adapted to absorb considerable forces.

By the arrangement of the invention comprising a rotating means, such as a toothed wheel, and a feeding device, such as a piston-cylinder assembly, to provide displacement of the second force means, a simple, low-cost solution is provided.

One advantage of using a pneumatic cylinder as feeding device is that it is a simple, ‘clean’ and inexpensive solution.

The advantages of a chambered doctor blade provided with at least one inventive arrangement are, as described above, that an automatic adjustment of the position of the chambered doctor blade in relation to the cylinder can be carried out to compensate for any wear of the blades of the chambered doctor blade. In addition, a chambered doctor blade provided with at least two arrangements offers the advantage of allowing automatic, parallel adjustment. The advantages of a corresponding printing unit follow from that stated above.

### BRIEF DESCRIPTION OF THE DRAWINGS

The invention and its advantages will be described in more detail below with reference to the accompanying schematic drawings, which by way of example illustrate currently preferred embodiments. In the drawings,

FIG. 1 is a side view of a chambered doctor blade in an operative position in a printing unit according to prior-art technique;

FIG. 2 is an enlarged view of parts of the inventive arrangement;

FIG. 3 is a view of the inventive arrangement along the line III-III in FIG. 2; and

FIGS. 4 and 5 illustrate parts of the inventive arrangement according to a second embodiment, the views corresponding to FIGS. 2 and 3.

### DESCRIPTION OF PREFERRED EMBODIMENTS

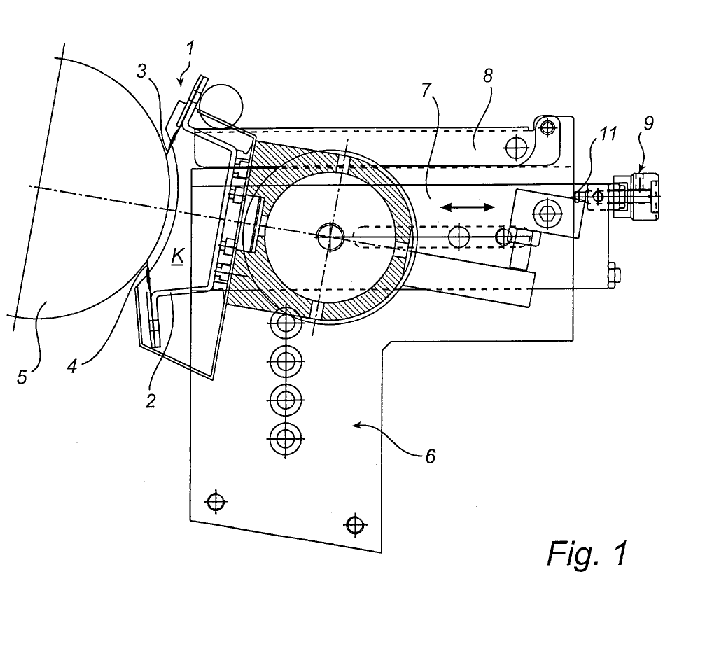

FIG. 1 shows a chambered doctor blade device 1 according to prior-art technique and parts of the printing unit in which the chambered doctor blade 1 is included. The chambered doctor blade 1 comprises an elongate frame 2, on which two parallel, elongate doctor blades 3, 4 are mounted at a distance from each other and parallel to the frame 2. In its operative position, the chambered doctor blade 1 is arranged parallel to and adjacent a cylinder 5 included in the printing unit in such manner that the doctor blades 3, 4 abut against the circumferential surface of the cylinder 5. The frame 2 of the chambered doctor blade 1 and the doctor blades 3, 4 define, together with the circumferential surface of the cylinder 5 and end seals (not shown) provided at the ends of the chambered doctor blade 1, an elongate chamber K holding printing ink or the like to be applied to the cylinder 5. At its ends, the chambered doctor blade 1 is supported on guides 7 (only one is shown) which are movable in relation to the fixed parts 6 of the printing unit. The chambered doctor blade 1 may be moved to its operative position and applied against the cylinder 5 by the force exerted by a first force means comprising, for example, a spring, such as a gas spring 8 arranged on the guide 7.

An arrangement according to a first preferred embodiment of the invention is shown in FIGS. 1-3, to which reference will be made below. Corresponding reference numerals have been used. At each end of the supporting system of the chambered doctor blade 1, an adjustable stop means or force-absorbing means 9 is provided. According to the first embodiment shown, said means comprises an adjusting screw 9, which is received in a rack 10 that is fixedly connected to the guide 7 and in a bore in said guide 7. The directions in which the guide 7 can move are indicated in the Figures by two-way arrows. When the chambered doctor blade 1 is applied against the cylinder 5 by the force exerted by the gas spring 8, part of the force exerted can be absorbed by the screw 9 as its nose 11 makes contact with the fixed part 6 of the printing unit.

The rack 10 and the screw 9 are movable together with the guide 7 as a single unit to allow the chambered doctor blade 1 to be moved to its operative position.

The screw 9 is provided with a toothed wheel 12, which is non-rotationally mounted on the screw 9. A piston-cylinder assembly 13 is mounted adjacent to the wheel 12. The assembly 13 may be, for example, a single-acting pneumatic cylinder. The cylinder 13 is provided with an arm or tongue 14 which can engage the wheel 12. The arm 14 is flexible and may also be L or T shaped to obtain reliable operation of the arm 14. With each active stroke of the pneumatic cylinder 13, which causes its arm 14 to make contact with the cogs of the wheel 12, the wheel 12 rotates by one cog in its forward direction and the position of the screw 9 is changed so that the guide 7 can move towards the cylinder 5. The length of stroke of the arm 14 exceeds the ‘length’ of one cog (cf. the spacing dimension of the wheel 12) and allows the wheel 12 to move freely, when the arm 14 is in its inoperative position, to enable manual adjustment of the screw 9 in both directions.

By using a typical wheel 12 with about 20 cogs, the chambered doctor blade 1 is moved less than one tenth of a millimeter closer to the screen roller 5 with each stroke of the cylinder 13. As the supply of compressed air to the cylinder 13 ceases, the cylinder returns to its inoperative position. In this position, the wheel 12 can be rotated manually in both directions. The cylinder 13 can only turn the wheel 12 in one direction, i.e. in the direction in which the chambered doctor blade 1 is applied against the screen roller 5. A wheel 12 with asymmetric cogs is shown in FIG. 3. A wheel 12 with symmetric cogs could also be used, but another angle of impact of the arm 14 would then be required.

The cylinder 13 can be controlled completely automatically with the aid of a counting unit (not shown) which receives pulses from, for example, an inductive sensor arranged adjacent to the rotating parts of the printing unit, such as a back-pressure cylinder. For instance, one complete turn may generate one pulse. Upon receipt of a predetermined number of pulses, the counter (not shown) provides an output signal to an electrically operated pneumatic valve (not shown), and compressed air is then admitted, for example, for one second so that compressed air is supplied to the cylinder 13 by the intermediary of a compressed-air line 15. The compressed air is then evacuated from the compressed-air line 15 and the cylinder 13, which is a single-acting, compressed-air cylinder of spring pull-back type, returns to its inoperative position. With each stroke of the cylinder 13, the wheel 12 rotates by one cog.

By mounting an arrangement according to the invention at both ends of the chambered doctor blade 1 and pneumatically interconnecting the two cylinders 13 by the intermediary of a pneumatic valve, so that they run in parallel, a parallel, stepwise displacement of the chambered doctor blade 1 towards the screen roller 5 can be obtained. The number of pulses required for the counter to provide an output signal to the pneumatic valve can be set by the operator. Suitably, the operator chooses the number taking into consideration the type of ink, screen roller and doctor blades with which the printing unit concerned is equipped. The operator may change the chosen number of pulses at any time.

The arrangement of the invention allows manual adjustment of the application of the chambered doctor blade 1 against the screen roller 5 in each printing unit, since the screws 9 can be adjusted in both directions when the cylinders 13 are located in their inoperative positions.

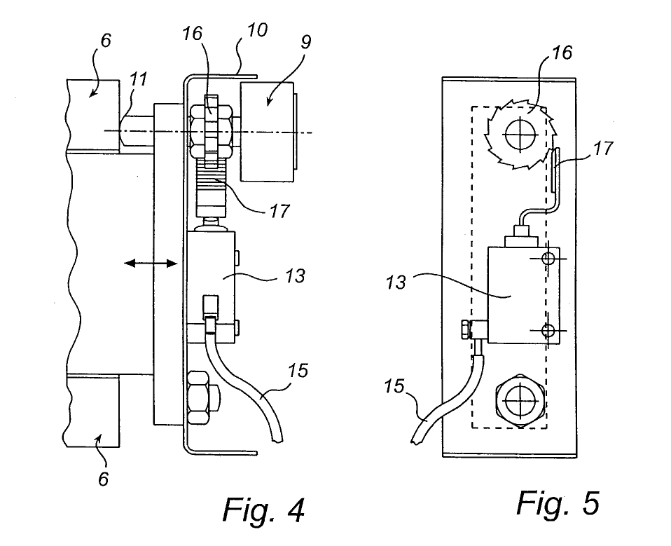

FIGS. 4 and 5 illustrate a second embodiment according to which a free wheel hub 16 with cogs/teeth along its circumference has been mounted on the screw 9 and is adapted to be advanced by means of a gear rack 17 for adjusting the screw 9. The inoperative position of the gear rack 17 is such as to allow manual adjustment of the screw 9 in both directions.

The invention has been described above with reference to embodiments selected as examples, and variations and modifications are feasible within the scope of the invention.

For instance, the arrangement may be used in a simpler form, in which the operator replaces the counter and instead activates a pneumatic valve in order to control the cylinders from a distance. This allows the operator to influence the application of the chambered doctor blade against the cylinder in a certain printing unit from a distance without having to climb up to the printing unit concerned to physically adjust the screw 9, as is the case when using manual adjustment.

The cylinder 13 provided with the arm 14 can be replaced by a step motor (not shown). Suitably, the step motor should be disconnectable to allow manual adjustment of the screw 9 in both directions. This is achieved by a step motor which does not use hold current.

Furthermore, the wheel 12 may be replaced by a free wheel hub provided with a lever (not shown). The lever should be disengageable to allow manual adjustment of the screw 9 in both directions.

It will be appreciated that the pneumatic means described above can be wholly or partly replaced by hydraulic or electromagnetic arrangements.

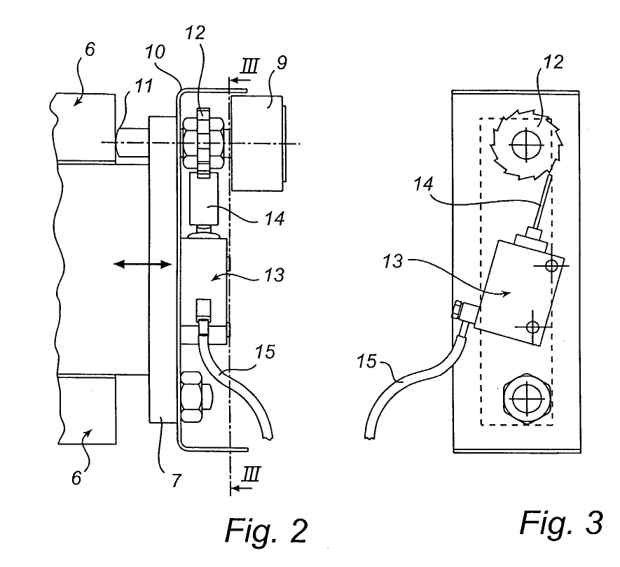

It is also evident that automatic adjustment of the second force means 9 could be achieved in both directions, for example by providing the screw 9 according to the embodiment shown in FIGS. 2 and 3 with two toothed wheels 12 and two cylinders 13.

Furthermore, it goes without saying that the inventive arrangement may also be used to apply single doctor blades against a cylinder.

What I claim and desire to secure by Letters Patent is:

1. An arrangement for a chambered doctor blade included in a printing unit having a rotatable cylinder, said arrangement comprising a first force means for applying the chambered doctor blade against the cylinder in an operative position and a second adjustable force means adapted to absorb at least part of a force generated by the first force means, wherein said second force means is automatically adjustable to allow the chambered doctor blade to be moved towards the cylinder in said operative position.

2. An arrangement according to claim 1, wherein said second force means is adjustably arranged on a rack which is movable relative to fixed parts of the printing unit and adapted to absorb at least part of said force by being applied against said fixed parts.

3. An arrangement according to claim 1, wherein said second force means is a threaded element.

4. An arrangement according to claim 1, further comprising a rotating means connected to the second force means and a feeding means adapted to engage said rotating means for obtaining said automatic adjustability.

5. An arrangement according to claim 4, wherein said rotating means is adapted to transfer the movement of said feeding means to said second force means in such manner that this force means is moved relative to said rack.

6. An arrangement according to claim 4, wherein said rotating means is a toothed wheel.

7. An arrangement according to claim 5, wherein said feeding means consists of a piston-cylinder assembly having an arm which is adapted to engage said rotating means for adjusting the position of said second force means.

8. An arrangement according to claim 7, wherein said piston-cylinder assembly is a pneumatic cylinder.

9. A chambered doctor blade for printing units, provided with at least one arrangement having a rotatable cylinder, said arrangement comprising a first force means for applying the chambered doctor blade against the cylinder in an operative position and a second adjustable force means adapted to absorb at least part of a force generated by the first force means, wherein said second force means is automatically adjustable to allow the chambered doctor blade to be moved towards the cylinder in said operative position.

10. A chambered doctor blade according to claim 9, which is provided with at least two arrangements, each arrangement having a rotatable cylinder, said arrangement comprising a first force means for applying the chambered doctor blade against the cylinder in an operative position and a second adjustable force means adapted to absorb at least part of a force generated by the first force means, wherein said second force means is automatically adjustable to allow the chambered doctor blade to be moved towards the cylinder in said operative position, the arrangements being located at a distance from each other and adapted to interact for parallel movement of the chambered doctor blade.

11. A printing unit, having at least one chambered doctor blade provided with at least one arrangement having a rotatable cylinder, said arrangement comprising a first force means for applying the chambered doctor blade against the cylinder in an operative position and a second adjustable force means adapted to absorb at least part of a force generated by the first force means, wherein said second force means is automatically adjustable to allow the chambered doctor blade to be moved towards the cylinder in said operative position.

12. A printing unit according to claim 11, wherein the at least one chambered doctor blade is provided with at least one more arrangement of said type, the arrangements being located at a distance from each other and adapted to interact for parallel movement of the chambered doctor blade.
